(19) United States
(12) Patent Application Publication
(10) Pub. No.: US 2007/0092007 A1
(43) Pub. Date: Apr. 26, 2007

(54) Methods and systems for video data processing employing frame/field region predictions in motion estimation

(75) Inventor: Cheng-Tsai Ho, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/256,872

(22) Filed: Oct. 24, 2005

(51) Int. Cl. H04N 11/02; H04N 11/04

(52) U.S. Cl. 375/240.16; 375/240.24

(57) ABSTRACT

Methods and systems for video data processing. A current picture and a reference picture in a sequence of pictures are provided. A portion of the current picture is acquired as a prediction region. A portion of the reference picture is repeatedly acquired as a search window until all potential portions of the reference picture are completely processed. It is determined that at least one matching score denoting the extent of matching between the prediction region and the search window is calculated by a frame block matching procedure or a field block matching procedure contingent upon the content of the search window.

### BACKGROUND

The invention relates to video encoding, and more particularly, to motion estimation methods and systems employing frame/field region prediction.

A video sequence is composed of a series of still pictures taken at closely spaced intervals in time that are sequentially displayed to provide the illusion of continuous motion. Each picture may be described as a two-dimensional array of samples, or “pixels”. Each pixel describes a specific location in the picture in terms of, for example, brightness, saturation and hue. Each horizontal line of pixels in the two-dimensional picture is called a raster line. Pictures may be comprised of a single frame or two fields.

When sampling or displaying a picture of video, the video picture may be “interlaced” or “progressive.” Progressive video consists of pictures in which the raster lines are sequential in time, as shown in FIG. 1A. The MPEG-1 standard allows only progressive pictures. Alternatively, each picture may be divided into two interlaced fields, as shown in Figs. 1B-1 to 1B-3. Each field has half the lines in the full picture and the fields are interleaved such that alternate lines in the picture belong to alternative fields. In an interlaced picture composed of two fields, one field is referred to as the “top” field, as shown in Fig. 1B-2, while the other is called the “bottom” field, as shown in FIG. 1B-3. The MPEG-2 standard allows both progressive and interlaced video.

Motion estimation is the process of estimating the displacement of a portion of an image between neighboring pictures. For example, a moving soccer ball will appear in different locations in adjacent pictures. Displacement is described as the motion vectors that give the best match between a specified region, e.g., the ball, in the current picture and the corresponding displaced region in a preceding or upcoming reference picture. The difference between the specified region in the current picture and the corresponding displaced region in the reference picture is referred to as “residue”.

In order to improve the accuracy of block matching in motion estimation, it is first determined whether a block in the current picture, prepared for prediction, is predicted by a frame prediction mode or a field prediction mode. When a frame prediction mode is determined, a frame block matching procedure is employed to determine the best matching block between the current and reference pictures, and otherwise, when a field prediction mode is determined, a field block matching procedure is employed. Typically, such selections of block matching procedures are performed contingent upon the content in the current picture.

### SUMMARY

Methods and systems for video data process performed by a motion estimator are provided. An embodiment of a video data process method comprises the following steps. A current picture in a sequence of pictures and a reference picture utilized to predict the current picture are provided. A portion of the current picture is acquired as a prediction region. A portion of the search area in the reference picture is repeatedly acquired as a search window until all portions of the search area are completely processed. It is determined that at least one matching score denoting the extent of matching between the prediction region and the search window is calculated by a frame block matching procedure or a field block matching procedure contingent upon the content of the search window.

An embodiment of determining the algorithm for calculating the matching score further comprises acquiring a region type determination result comprising information regarding that each of a plurality of predetermined regions in the search window is a progressive region or an interlaced region. If most pixels in the search window are located in at least one progressive region according to the result of the region type determination, it is determined that one matching score is calculated by the frame block matching procedure, and otherwise, determining that four matching scores are calculated by the field block matching procedure.

An embodiment of a method for video data processing may further comprise calculating one matching score when it is determined to perform frame block matching, where the matching score denotes the extent of matching between the entire prediction region and the entire search window.

An embodiment of a method for video data processing may further comprise steps as described in the following. When it is determined to perform field block matching, the prediction region is divided into a top prediction field and a bottom prediction field, each prediction field having half the lines in the prediction region and the prediction fields being interlaced such that alternate lines in the prediction region belong to alternative prediction fields. The search window is divided into a top search field and a bottom search field, each search field having half the lines in the search window and the search fields being interlaced such that alternate lines in the search window belong to alternative search fields. Four matching scores are calculated, respectively denoting the extent of matching between the top prediction field and the top search field, between the top prediction field and the bottom search field, between the bottom prediction field and the top search field, and, between the bottom prediction field and the bottom search field.

An embodiment of a method for video data processing may further comprise the following steps. After all potential portions of the reference picture are completely processed, a motion vector for the prediction region is generated contingent upon the calculated matching scores, the motion vector denoting the displacement of the prediction region with respect to one specific search window, in which the replacing search window is the best matching region with the optimum matching score among all potential search windows. Information regarding whether the vector type of the generated motion vector is a progressive vector or an interlaced vector, is stored in a region type determination result.

An embodiment of a system for video data processing comprises a motion estimator. A current picture in a sequence of pictures and a reference picture utilized to predict the current picture are provided , acquires a portion of the current picture as a prediction region and repeatedly acquires a portion of the reference picture as a search window until all potential portions of the reference picture are completely processed. For each acquired search window, the motion estimator determines that at least one matching score denoting the extent of matching between the prediction region and the search window is calculated by a frame block matching procedure or a field block matching procedure contingent upon the content of the search window.

An embodiment of a motion estimator may further provide a region type determination result comprising information regarding that each of a plurality of predetermined regions in the search window is a progressive region or an interlaced region, and detect whether most pixels in the search window are located in at least one progressive region according to the result of the region type determination. If so, the motion estimator may determine that one matching score is calculated by frame block matching, and otherwise, determine that four matching scores are calculated by field block matching.

The motion estimator, when performing frame block matching, may further calculate one matching score denoting the extent of matching between the entire prediction region and the entire search window.

The motion estimator, when performing field block matching, may further divide the prediction region into a top prediction field and a bottom prediction field, each prediction field having half the lines in the prediction region and the prediction fields being interlaced such that alternate lines in the prediction region belong to alternative prediction fields. The motion estimator may further divide the search window into a top search field and a bottom search field, each search field having half the lines in the search window and the search fields being interlaced such that alternate lines in the search window belong to alternative search fields. Thereafter, the motion estimator may further calculate four matching scores respectively denoting the extent of matching between the top prediction field and the top search field, between the top prediction field and the bottom search field, between the bottom prediction field and the top search field, and, between the bottom prediction field and the bottom search field.

The motion estimator, after all potential portions of the reference picture are completely processed, may further generate a motion vector for the prediction region contingent upon the calculated matching scores, the motion vector denoting the displacement of the prediction region with respect to one specific search window, in which the replacing search window is the best matching region with the optimum matching score among all potential search windows. Thereafter, the motion estimator may further store information regarding whether a vector type of the generated motion vector is a progressive vector or an interlaced vector, in a region type determination result.

The matching scores may be computed or represented by cross correlation function (CCF), pel difference classification (PDC), mean absolute difference (MAD), mean squared difference (MSD) or integral projection (IP) . The current picture may be a P-picture or a B-picture. The reference picture may be a previous I- or P-picture, or a subsequent I- or P-picture.

### DESCRIPTION OF THE DRAWINGS

The invention will become more fully understood by referring to the following detailed description of embodiments with reference to the accompanying drawings, wherein:

FIG. 1A is a diagram of a progressive picture;

FIGS. 1B-1 to 1B-3 are diagrams of an interlaced picture;

FIG. 2 is a diagram showing the picture architecture of an exemplary MPEG-2 video bitstream;

FIG. 3 is a diagram illustrating exemplary predictions;

FIG. 4 is a diagram of bidirectional prediction;

FIG. 5 is a diagram of a hardware environment applicable to an embodiment of a video data processing system;

FIG. 6 is a diagram applicable to an embodiment of a video encoder;

FIGS. 7, 8a and 8b are flowcharts showing various exemplary embodiments of methods for video data processing employing frame/field region prediction in motion estimation;

FIG. 9a is a schematic diagram showing an exemplary result of the region type determination for a search area in a reference picture;

FIGS. 9b and 9c are schematic diagrams showing exemplary region type determinations for two different search windows.

### DESCRIPTION

A digital video stream includes a series of still pictures, requiring considerable storage capacity and transmission bandwidth during video processing. A 90-min full color video stream, having a resolution of 640×480 pixels/picture rendered at a rate of 15 pictures/sec, requires bandwidth of 640×480 pixels/picture×3 bytes/pixel×15 pictures/sec=13.18 MB/sec and file size of 13.18 MB/sec×90×60=69.50 GB, for example. Such a sizeable digital video stream is difficult to store and transmit in real time, thus, many compression techniques have been introduced.

MPEG standards ensure video encoding systems create standardized files that can be opened and played on any system with a standards-compliant decoder. Digital video contains spatial and temporal redundancies, which may be compressed without significant sacrifice. MPEG encoding is a generic standard, intended to be independent of a specific application, involving compression based on statistical redundancies in temporal and spatial directions. Spatial redundancy is based on the similarity in color values shared by adjacent pixels. MPEG employs intra-picture spatial compression on redundant color values using DCT (Discrete Cosine Transform) and quantization. Temporal redundancy refers to identical temporal motion between successive video pictures, providing smooth, realistic motion in video. MPEG relies on prediction, more precisely, motion-compensated prediction, for temporal compression between pictures. To create temporal compression, MPEG utilizes I-pictures (Intra-coded pictures), B-pictures (bidirectionally predictive-coded pictures) and P-pictures (predictive-coded pictures). I-picture is an intra-coded picture, a single image heading sequence, with no reference to previous or subsequent pictures. P-pictures are forward-predicted pictures, encoded with reference to a previous I- or P-picture, with pointers to information in a previous picture. B-pictures are encoded with reference to a previous reference picture, a subsequent reference picture, or both. Motion vectors employed may be forward, backward,. or both.

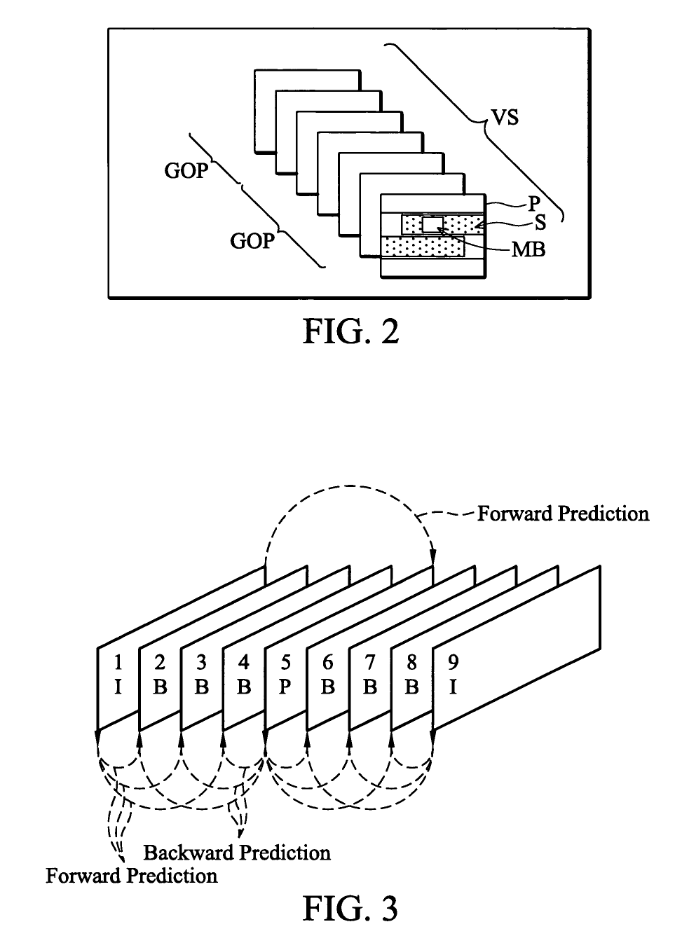

FIG. 2 is a diagram showing the picture architecture of an exemplary MPEG-2 video bitstream. A video stream (VS) is composed of multiple pictures or groups of pictures (GOPs). The picture, a basic unit in compression, includes three types of picture, I-picture, P-picture, and B-picture. Each picture is divided horizontally into fixed lengths to produce multiple slices (S) as the minimum unit in signal synchronization and error control. Each S, for example, composed of multiple macroblocks (MB), where MB is the minimum unit in color sampling, motion estimation and motion compensation. Each MB, typically composed of four blocks of 8×8 pixels is the minimum unit in DCT.

FIG. 3 is a diagram illustrating exemplary predictions for video encoding. In MPEG-2 video, I-picture has no reference picture, and is compressed by quantization and variable length coding methods, thus, it can be treated as an initiation point for decompression without other pictures. The I-picture is the first picture in the VS or GOP, and those following are P-pictures and B-pictures. Hence, I-pictures require protection during file transfer to prevent data loss and further damage to subsequent pictures. A P-picture refers to one reference picture, such as an I-picture or prior P-picture, to locate similar regions. When there is no similar region, the regions in the P-picture can be compressed using intra-coding. Basically, P-pictures are composed of both intra-coded regions and predictive-coded (or inter-coded) regions, where the content of the predictive-coded region is a motion vector which is calculated according to the reference picture. A B-picture refers to both subsequent (backward prediction) and previous (forward prediction) reference pictures to locate similar regions.

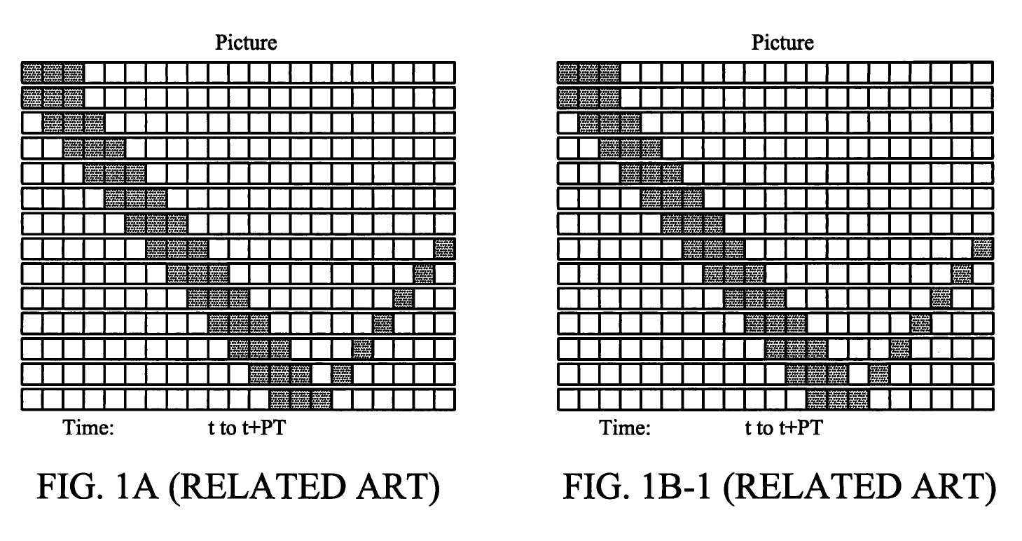

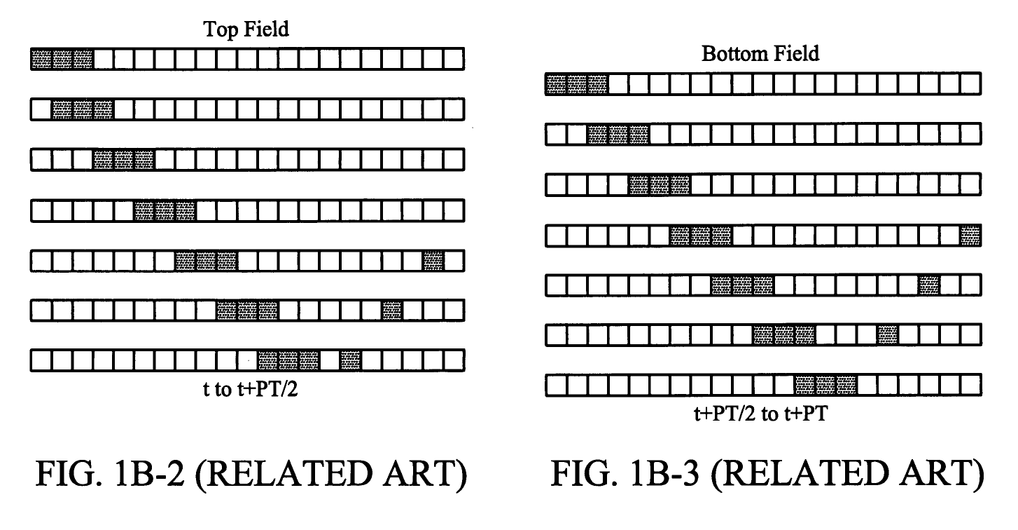

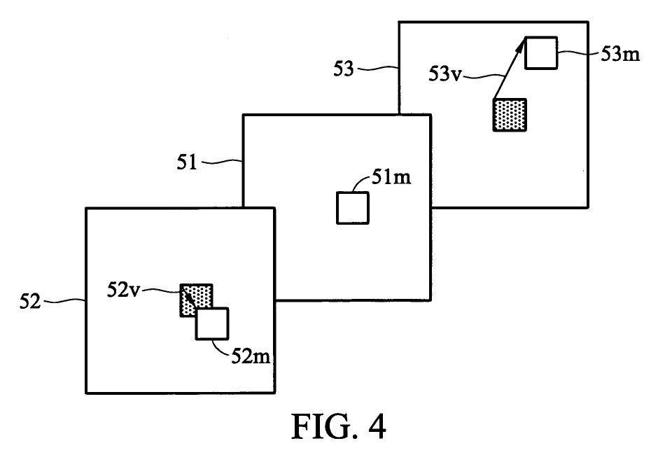

In a sequence of pictures, the current picture is predicted from a previous picture known as a reference picture. However, motion estimation techniques may choose different block sizes such as 4×4, 4×8, 8×4, 8×8, 8×16, 16×8, 16×16 and similar, and may vary the size of the blocks within a given picture. Each block is compared to a block in the reference picture using some error measure, and the best matching block is selected. Referring to FIGS. 1A, 1B-1 to 1B-3, for each specific region containing at least one block in the current picture, it is first determined whether a region in the current picture, prepared for prediction, is predicted by a frame prediction mode or a field prediction mode. When a frame prediction mode is determined, a frame block matching procedure is employed to determine the best matching region between the current and reference pictures, and otherwise, when a field block matching procedure is determined, a field block matching procedure is employed. Such selections of block matching procedures are performed contingent upon the content in the reference picture other than the current picture. The search is conducted over a predetermined search area. A motion vector denoting the displacement of the region in the reference picture with respect to the region in the current picture, is determined. When a previous picture is used as a reference, the prediction is referred to as forward prediction. If the reference picture is a future picture, the prediction is referred to as backward prediction. Backward prediction is typically used with forward prediction, and is referred to as bidirectional prediction. FIG. 4 is a diagram illustrating bidirectional prediction. In B-picture 51, the bi-directional motion-compensated block 51m can have two motion vectors, the forward motion vector 52v which references the best matching region 52m in the previous I- or P-picture 52, and the backward motion vector 53v which references the best matching region 53m in the next I- or P-picture 53.

Motion estimation processes are used to eliminate the large amount of temporal and spatial redundancy that exists in video sequences. The better the estimation, the smaller the error and transmission bit rate. If a scene has no movement, a good prediction is that for a particular MB in the current picture is the same MB in the previous or next picture and the error is zero. There are various motion estimation processes, such as full search and hierarchical search block-matching processes, for inter-picture predictive coding.

Moreover, to evaluate the accuracy of a match between a prediction region in the reference picture and a region being encoded in the current picture, various matching criteria such as cross correlation function (CCF), pel difference classification (PDC), mean. absolute difference (MAD), mean squared difference (MSD), integral projection (IP) and the like exist.

In a full search block-matching process, each MB within a given search window is compared to the current MB and the best match is obtained (based on one comparison or matching criterion) . Although, this process is the best in terms of the quality of the predicted image and the simplicity of the algorithm, it consumes the most computation power. Since motion estimation is the most computationally intensive operation in the coding of video streams, various signature-based search block-matching processes, such as hierarchical search, three step search (TSS), two dimensional logarithmic search (TDL), binary search (BS), four step search (FSS), orthogonal search algorithm (OSA), one at a time algorithm (OTA), cross search algorithm (CSA), diamond search (DS) and the like, are introduced.

Coarse-to-fine hierarchical searching block-matching processes may be further adopted in motion estimation. One of the well-known examples of these processes is the mean pyramid. In the mean pyramid methods, different pyramidal images are constructed by sub-sampling. Then a hierarchical search motion vector estimation proceeding from the higher level to the lower levels reduces the computational complexity and obtains high quality motion vectors. To remove the effects of noise at a higher level, image pyramids are constructed using a low pass filter. A simple averaging is used to construct the multiple-level pyramidal images. For example, a pyramid of images can be built by the following equation:

$${g}_{L} ( p , q ) = ⌈ ( 1 / 4 ) \cdot ( {\sum }_{u = 0}^{1} {\sum }_{v = 0}^{1} {g}_{L - 1} ( 2 p + u , 2 q + v ) ) ⌉$$

where g_{L}(p,q) represents the gray level at the position (p,q) of the Lth level and g_{O}(p,q) denotes the original image. The construction of mean pyramid by simple non-overlapping low pass filtering is completely by assigning a mean gray level of pixels in a low pass window to a single pixel at the next level. The truncated mean value of four pixels at the lower level is recursively used in generating mean pyramid.

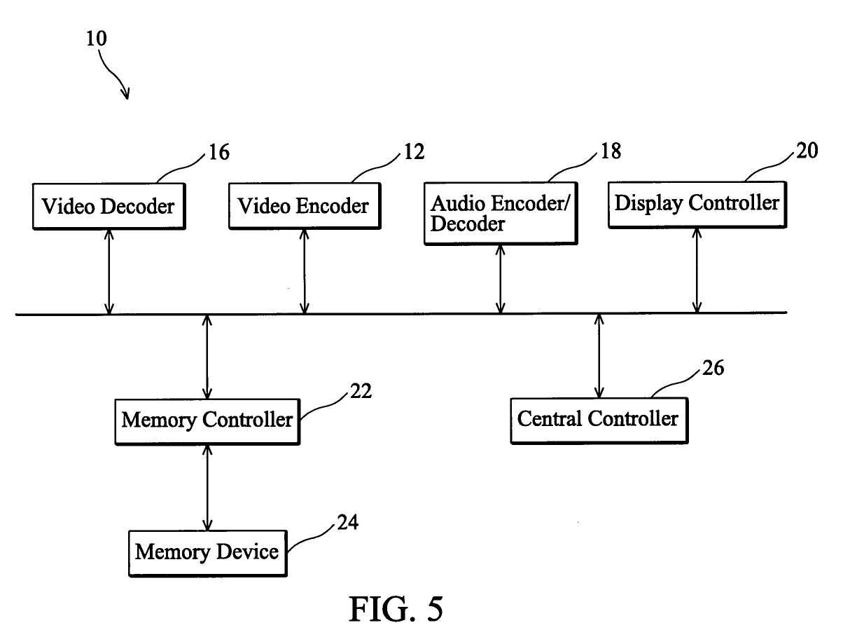

FIG. 5 is a diagram of a hardware environment applicable to an embodiment of a video data processing system 10, comprising a video encoder 12, a video decoder 16, an audio encoder/decoder 18, a display controller 20, a memory controller 22, a memory device 24, and a central controller 26. The memory device 24 is preferably a random access memory (RAM), but may also include read-only memory (ROM) or flash memory. The memory device 24 temporarily stores data for video encoding. The central controller 26 controls the video decoder 16, video encoder 12, audio encoder/decoder 18, display controller 20 and memory controller 22 to direct video encoding functions.

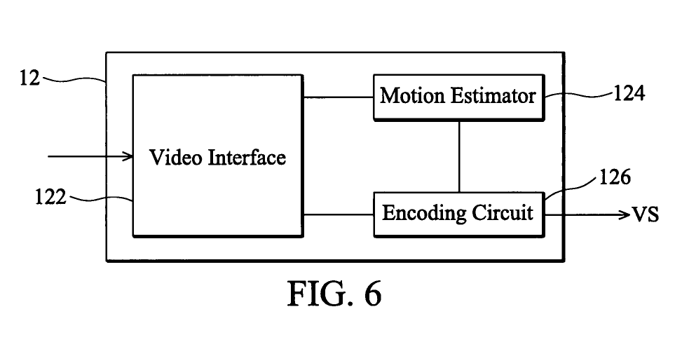

FIG. 6 is a diagram applicable to an embodiment of a video encoder 12, comprising a video interface 122, a motion estimator 124, and an encoding circuit 126. The video encoder 12 encodes digitized video data to generate a video bitstream VS. The motion estimator 124, coupling to the video interface 122, performs various motion estimation methods for regions in the digitized video data. The encoding circuit 126, coupling to the video interface 122 and motion estimator 124, controls the entire encoding process, encodes estimated pictures by steps such as DCT, Quantization, VLC or others, to generate a VS, and reconstructs reference pictures for motion estimation using Inverse Quantization, Inverse DCT (IDCT), Motion Compensation (MC) or others.

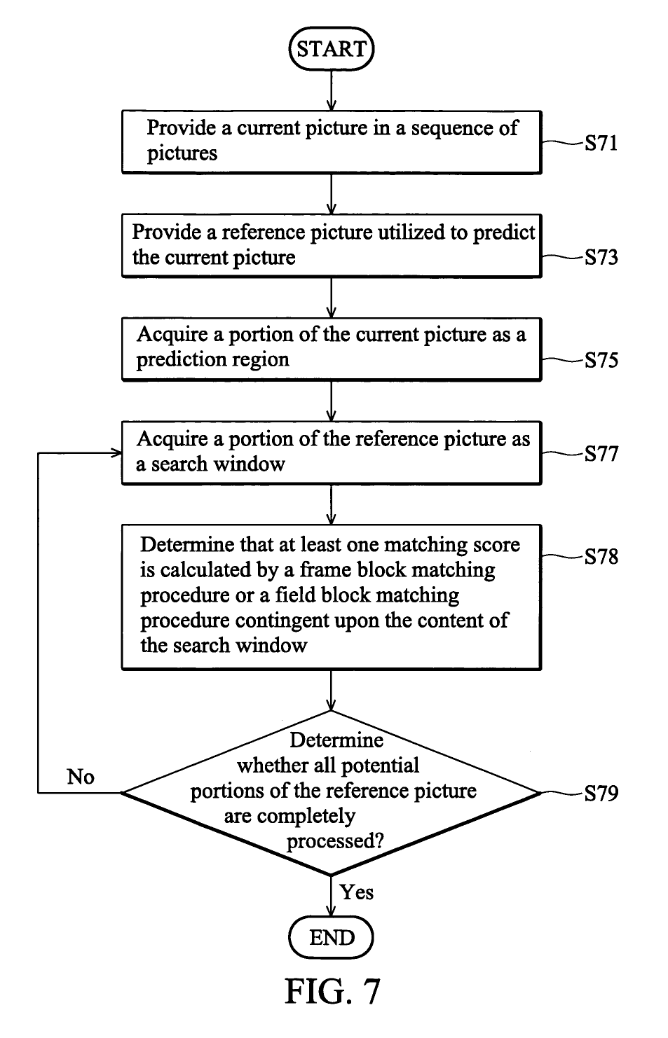

FIG. 7 is a flowchart showing an embodiment of a method for video data processing employing frame/field region prediction in motion estimation, utilized in the motion estimator 124 (as shown in FIG. 6). In step S71, the current picture in a sequence of pictures is provided. The current picture may be a P-picture or a B-picture. In step S73, a reference picture utilized to predict the current picture is provided. The reference picture may be a previous I- or P-picture, or a subsequent I- or P-picture. In step S75, a portion of the current picture is acquired as a prediction region. In step S77, a portion of the reference picture is acquired as a search window. The search window may be acquired by a full search block-matching process, TSS, TDL, BS, FSS, OSA, OTA, CSA or DS. In step S78, it is determined that at least one matching score denoting the extent of matching between the prediction region and the search window is calculated by a frame block matching procedure or a field block matching procedure contingent upon the content of the search window. The matching scores may be represented by CCF, PDC, MAD, MSD or IP. In step S79, it is determined whether all potential portions of the reference picture are completely processed, and, if so, ends the entire process, and otherwise, the process proceeds to step S77.

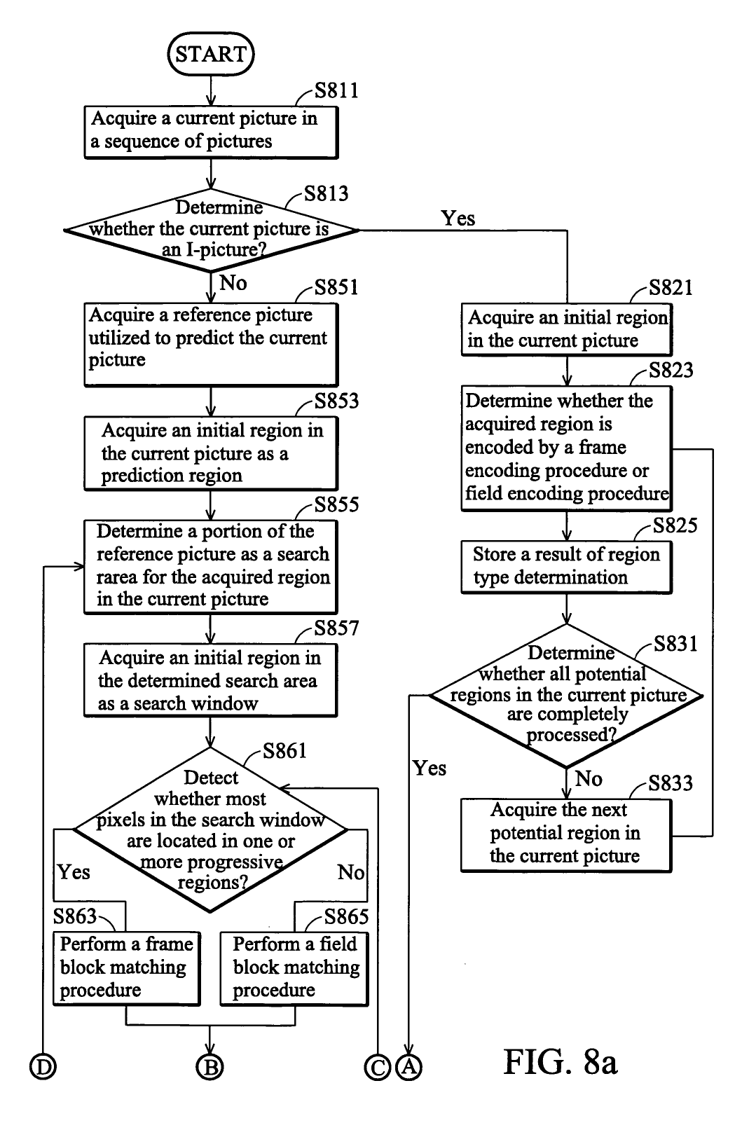

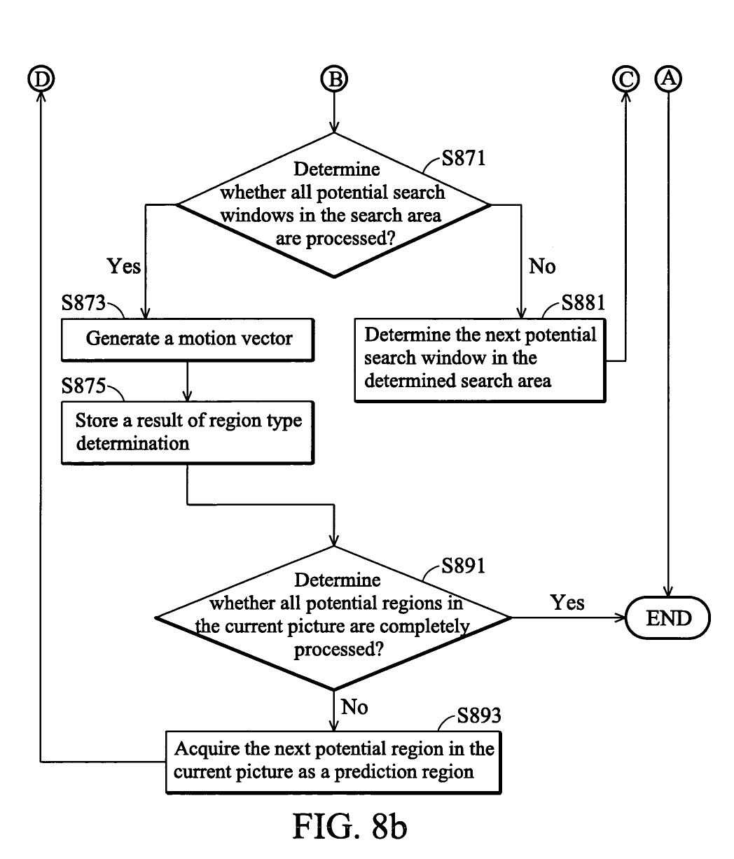

FIGS. 8a and 8b are flowcharts showing an embodiment a method for video data processing employing frame/field region prediction in motion estimation, utilized in the motion estimator 124 (as shown in FIG. 6). In step S811, the current picture, to be compressed, in a sequence of pictures is acquired. In step S813, it is determined whether the current picture is an I-picture, and, if so, the process proceeds to step S821, and otherwise, to step S851.

Steps S821 to S833 describe a process utilized to perform an intra-coded operation for an I-picture. In step S821, an initial region in the current picture is acquired. The acquired region may be a MB containing 16×16 pixels, or a region with a particular block size such as 4×4, 4×8, 8×4, 8×8, 8×16, 16×8, and similar. Note that it may vary the size of the acquired region within the current picture. In step S823, it is determined whether the acquired region is encoded by a frame encoding procedure or field encoding procedure. It may be determined according to various well-known field spatial correlation methods. The acquired region is determined to be encoded by a frame encoding procedure, that is to say, it assumes that the acquired region is a “progressive” region similar to a “progressive” picture as shown in FIG. 1A. The acquired region is determined to be encoded by a field encoding procedure, that is to say, it assumes that the acquired region is an “interlaced” region similar to an “interlaced” picture as shown in FIG. 1B. In the frame encoding procedure, various well-know intra-coded methods may be adopted to encode the entire region referred to as FIG. 1A. In the field encoding procedure, the acquired region is divided into two interlaced fields referred to as the “top” field as shown in FIG. 1B-2, and the “bottom” field as shown in FIG. 1B-3, and subsequently, various well-know intra-coded methods may be adopted to encode the top and bottom fields respectively. In step S825, a result of region type determination is stored, comprising information regarding that the acquired region is a progressive region or interlaced region. Note that the determination result can be utilized in subsequent motion estimation for the next picture, as shown in step S861, the details of which are described in the following. In step S831, it is determined whether all potential regions in the current picture, required to be encoded, are completely processed, and, if so, ends the entire process, and otherwise, to step S833. In step S833, the next potential region in the current picture, required to be predicted, is acquired.

Steps S851 to S893 describe a process utilized to perform an inter-coded operation for a P-picture or B-picture. In step S851, a reference picture is acquired, utilized to predict the current picture. The acquired reference picture may be a previous I- or P- picture utilized in a forward-predicted mechanism, or a subsequent I- or P-picture utilized in a backward-predicted mechanism. In step S853, an initial region in the current picture, required to be predicted, is acquired as a prediction region. In step S855, for the acquired region in the current picture, a portion of the reference picture is determined as a search area. The search area may be determined by a well-known search block-matching process such as full search block-matching, hierarchical search, TSS, TDL, BS, FSS, OSA, OTA, CSA, DS and similar. In step S857, an initial region in the determined search area, having the same size as the prediction region, is acquired as a search window. The search window may be acquired by a well-known search block-matching process, such as full search block-matching, hierarchical search, TSS, TDL, BS, FSS, OSA, OTA, CSA, DS and similar.

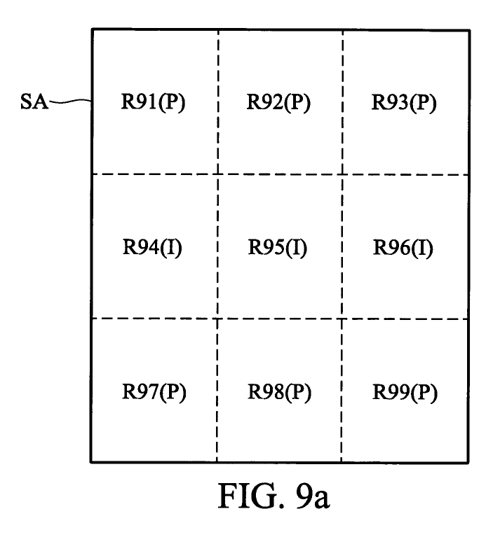

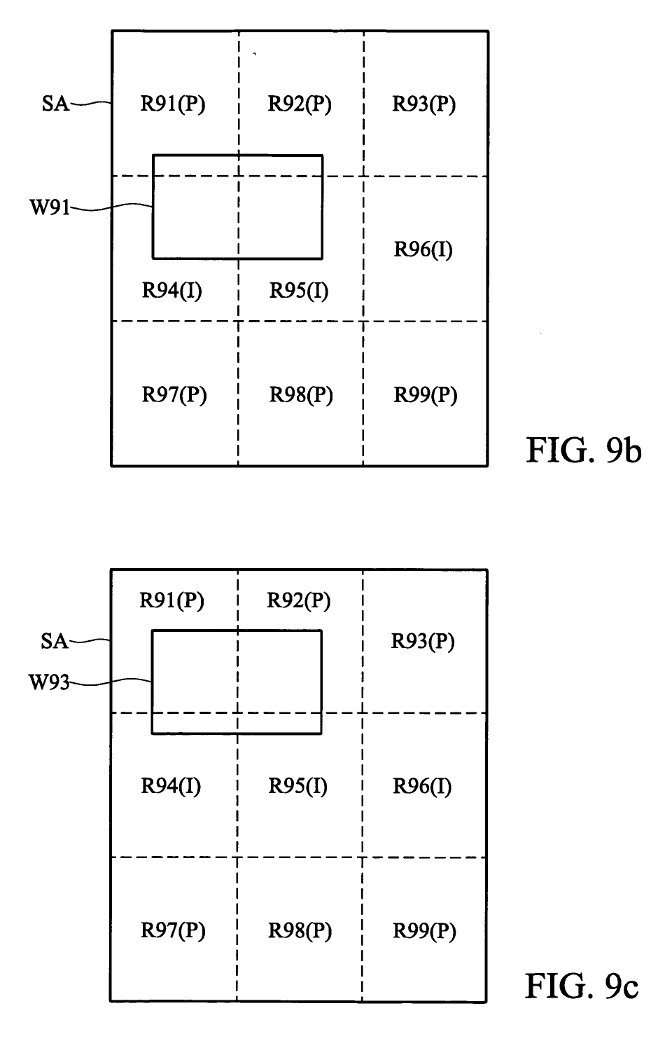

In step S861, it is detected whether most pixels in the search window are located in one or more progressive regions contingent upon the stored region type determination result for the reference picture, comprising information regarding that each region thereof is a progressive region or interlaced region. If so, the process proceeds to step S863, otherwise, to step S865. FIG. 9a is a schematic diagram showing an exemplary region type determination result for a search area in a reference picture. The search area SA contains nine predetermined regions R91 to R99. The result of the region type determination comprises information regarding that regions R91 to R93 and R97 to R99 are progressive regions, and regions R94 to R96 are interlaced regions. For step S861, two examples are further introduced in the following. FIGS. 9b and 9c are schematic diagrams showing exemplary region type determinations for two different search windows. In FIG. 9b, most pixels in an exemplary search window W91 are located in interlaced regions R94 and R95. In FIG. 9c, most pixels in an exemplary search window W93 are located in progressive regions R91 and R92.

In step S863, a frame block matching procedure is performed, where various matching criteria, such as CCF, PDC, MAD, MSD, IP and the like, may be employed to calculate a matching score denoting the extent of matching between the prediction region in the current picture and the search window in the reference picture. In step S865, a field block matching procedure is performed. In this step, the prediction region may be divided into two fields, top and bottom prediction fields, and the search window may also be divided into two fields, top and bottom search fields, similar to FIGS. 1B-2 and -3. Various matching criteria, such as CCF, PDC, MAD, MSD, IP and the like, may be employed to calculate four matching scores respectively denoting the extent of matching between the top prediction field and the top search field, between the top prediction field and the bottom search field, between the bottom prediction field and the top search field, and, between the bottom prediction field and the bottom search field.

In step S871, it is determined whether all potential search windows in the search area are processed, and, if so, the process proceeds to step S873, and otherwise, to step S881. In step S873, a motion vector is generated contingent upon the calculated matching scores. The motion vector (referred to as a progressive vector) may denote the displacement of the region (a progressive region) in the current picture with respect to a specific search window (also a progressive region) in the reference picture, in which the replacing search window is the best matching region with the optimum matching score among all potential search windows. The motion vector (referred to as an interlaced vector) may contain a pair of sub motion vectors, one denoting the displacement of the top prediction field in the reference picture with respect to a top or bottom search field in the reference picture, and the other denoting the displacement of the bottom prediction field in the current picture with respect to a top or bottom search field in the reference picture, in which the replaced search fields are the best matching region with the optimum matching score among all potential search windows. In step S881, the next potential search window in the determined search area is determined.

In step S875, information regarding that a vector type of the generated motion vector, such as a progressive vector or interlaced vector, in the current picture is stored in the result of the region type determination. Note that after all potential motion vectors are completely generated, the result of the region type determination comprises information regarding that each motion vector in the current picture is a progressive vector or an interlaced vector. This region type determination result may be utilized in subsequent motion estimations for another picture having been deduced by analogy.

In step S891, it is determined whether all potential regions in the current picture, required to be predicted, are completely processed, and, if so, ends the entire process, and otherwise, the process proceeds to step S893. In step S893, the next potential region in the current picture, prepared for prediction, is acquired as a prediction region.

As the conventional methods determining that at least one matching score is calculated by a frame block matching procedure or a field block matching procedure contingent upon information of a current picture prepared to be compressed, the disclosed methods performing such determinations contingent upon information of the reference picture may gain greater computation speed, consume less computation power and improve estimation accuracy.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A method for video data processing comprising:
providing a current picture in a sequence of pictures;
providing a reference picture utilized to predict the current picture;
acquiring a portion of the current picture as a prediction region;
repeatedly acquiring a portion of a search area in the reference picture as a search window for the prediction region until all potential portions of the search area are completely processed; and
determining that at least one matching score denoting the extent of matching between the prediction region and the search window is calculated by a frame block matching procedure or a field block matching procedure contingent upon the content of the search window.

2. The method of claim 1, wherein the determination step further comprises:
providing a region type determination result comprising information regarding that each of a plurality of predetermined regions in the search window is a progressive region or an interlaced region;
detecting whether most pixels in the search window are located in at least one progressive region according to the result of the region type determination; and
if so, determining that one matching score is calculated by the frame block matching procedure, and otherwise, determining that four matching scores are calculated by the field block matching procedure.

3. The method of claim 2, wherein the matching scores are represented by cross correlation function (CCF), pel difference classification (PDC), mean absolute difference (MAD), mean squared difference (MSD), or integral projection (IP).

4. The method of claim 1 further comprising, when determining the frame block matching procedure, calculating one matching score denoting the extent of matching between the entire prediction region and the entire search window.

5. The method of claim 1 further comprising:
when determining the field block matching procedure, dividing the prediction region into a top prediction field and a bottom prediction field, each prediction field having half the lines in the prediction region and the prediction fields being interlaced such that alternate lines in the prediction region belong to alternative prediction fields;
dividing the search window into a top search field and a bottom search field, each search field having half the lines in the search window and the search fields being interlaced such that alternate lines in the search window belong to alternative search fields;
calculating four matching scores respectively denoting the extent of matching between the top prediction field and the top search field, between the top prediction field and the bottom search field, between the bottom prediction field and the top search field, and, between the bottom prediction field and the bottom search field.

6. The method of claim 1, wherein the current picture is a P-picture or a B-picture.

7. The method of claim 1, wherein the reference picture is a previous I- or P-picture, or a subsequent I- or P-picture.

8. The method of claim 1 further comprising:
after all potential portions of the reference picture are completely processed, generating a motion vector for the prediction region contingent upon the calculated matching scores, the motion vector denoting the displacement of the prediction region with respect to one specific search window, in which the replacing search window is the best matching region with the optimum matching score among all potential search windows; and
storing information regarding that a vector type of the generated motion vector, being a progressive vector or interlaced vector, in a region type determination result.

9. The method of claim 1, wherein the search window is acquired by a full search block-matching process, hierarchical search, three step search (TSS), two dimensional logarithmic search (TDL), binary search (BS), four step search (FSS), orthogonal search algorithm (OSA), one at a time algorithm (OTA), cross search algorithm (CSA), or diamond search (DS).

10. A system for video data processing, comprising:
a video interface, providing a sequence of pictures; and
a motion estimator coupled to the video interface, acquiring a portion of a current picture as a prediction region, repeatedly acquiring a portion of a reference picture as a search window until all potential portions of the reference picture are completely processed, and determining that at least one matching score denoting the extent of matching between the prediction region and the search window is calculated by a frame block matching procedure or a field block matching procedure contingent upon the content of the search window.

11. The system of claim 10, wherein the motion estimator provides a region type determination result comprising information regarding that each of a plurality of predetermined regions in the search window is a progressive region or an interlaced region, detects whether most pixels in the search window are located in at least one progressive region according to the result of the region type determination, and, if so, determines that one matching score is calculated by the frame block matching procedure, and otherwise, determines that four matching scores are calculated by the field block matching procedure.

12. The system of claim 11, wherein the matching scores are represented by cross correlation function (CCF), pel difference classification (PDC), mean absolute difference (MAD), mean squared difference (MSD), or integral projection (IP).

13. The system of claim 10, wherein the motion estimator, when determining the frame block matching procedure, calculates one matching score denoting the extent of matching between the entire prediction region and the entire search window.

14. The system of claim 10, wherein the motion estimator, when determining the field block matching procedure, divides the prediction region into a top prediction field and a bottom prediction field, each prediction field having half the lines in the prediction region and the prediction fields being interlaced such that alternate lines in the prediction region belong to alternative prediction fields, divides the search window into a top search field and a bottom search field, each search field having half the lines in the search window and the search fields being interlaced such that alternate lines in the search window belong to alternative search fields, and calculates four matching scores respectively denoting the extent of matching between the top prediction field and the top search field, between the top prediction field and the bottom search field, between the bottom prediction field and the top search field, and, between the bottom prediction field and the bottom search field.

15. The system of claim 10, wherein the current picture is a P-picture or a B-picture.

16. The system of claim 10, wherein the reference picture is a previous I- or P-picture, or a subsequent I- or P-picture.

17. The system of claim 10, wherein the motion estimator, after all potential portions of the reference picture are completely processed, generates a motion vector for the prediction region contingent upon the calculated matching scores, the motion vector denoting the displacement of the prediction region with respect to one specific search window, in which the replacing search window is the best matching region with the optimum matching score among all potential search windows, and stores information regarding that a vector type of the generated motion vector, being a progressive vector or interlaced vector, in a region type determination result.

18. The system of claim 10, wherein the search window is acquired by a full search block-matching, hierarchical search, three step search (TSS), two dimensional logarithmic search (TDL), binary search (BS), four step search (FSS), orthogonal search algorithm (OSA), one at a time algorithm (OTA), cross search algorithm (CSA), or diamond search (DS).
